(19) United States
(12) Patent Application Publication
(10) Pub. No.: US 2023/0334496 A1
(43) Pub. Date: Oct. 19, 2023

(54) AUTOMATED TRANSACTION CLUSTERING BASED ON RICH, NON-HUMAN FILTERABLE RISK ELEMENTS

(71) Applicant: Actimize LTD., Ra'anana (IL)

(72) Inventors: Shubh VACHHER, Chennai (IN); Anushri VIRKAR, Pune (IN); Pratik RAUSHAN, Pune (IN); Cuiwen LI, Mountain View, CA (US)

(21) Appl. No.: 17/719,452

(22) Filed: Apr. 13, 2022

(51) Int. Cl. G06Q 20/40; G06F 16/28

(52) U.S. Cl. CPC G06Q 20/4016; G06F 16/287

(57) ABSTRACT

A system and methods are provided to automatically analyze clusters of suspicious transactions. The system includes a processor configured to: receive a group of risk factors, and a group of suspicious transactions, each with a respective set of values for the risk factors. With a clustering algorithm, based on the risk factor values for the transactions, the processor is configured to generate a number of data clusters, and assign each transaction to a cluster. For each cluster, the processor is configured to, for each risk factor, compute a respective cluster mean and cluster standard deviation; identify risk factors for which the cluster standard deviation is below a respective threshold value; and generate a list of the identified risk factors and their respective cluster means and cluster standard deviations, ranked in order of their respective cluster standard deviations.

### TECHNICAL FIELD

The subject matter described herein relates to systems, methods, and devices for grouping suspicious transactions into clusters with identifiable characteristics that set them apart from one another, and from the full dataset of suspicious transactions.

### BACKGROUND

Transactions processed by a financial institution may be flagged with “alerts” that identify them as suspicious (e.g., potentially fraudulent) transactions. Alerted transactions may then be directed to a human fraud manager at the financial institution, who then divides them amongst a team of fraud analysts working under the fraud manager. This division is typically performed using simple filtering techniques, with characteristic readily identifiable by a human in near-real time, such as the dollar amount of the transaction, or the city from which the transaction originates. These filters tend to be quite simple, and may need to be updated frequently as the business climate changes. Furthermore, the filtered results may often represent a collection of dissimilar types of fraud. For example, the set of alerts from a particular city may include an online romance scam as well as a money mule scheme. The analyst then needs to address these varied types of alerts in different ways. For example, in one case the analyst may need to call the client to confirm the payment they made. In other cases within the same grouping, the analyst may need to file a SAR report, or escalate the fraud for more in-depth analysis. These varied responses can require repeated context switching, which may not allow for a streamlined alert solution pipeline. Even the resolutions for similar frauds by the same analyst can require context switching, since they may not be handled sequentially. Thus, a need exists.

Thus, it is to be appreciated that such commonly used alert filtering systems have numerous drawbacks, including subjectivity, inefficiency, long investigation times, inflexibility in the face of changing criminal behavior, overreliance on expert knowledge, uncertainty of results, and otherwise. Accordingly, long-felt needs exist for improved fraud management workflows that improve the productivity and efficiency of fraud analysis and thus reduce costs.

The information included in this Background section of the specification, including any references cited herein and any description or discussion thereof, is included for technical reference purposes only and is not to be regarded as subject matter by which the scope of the disclosure is to be bound.

### SUMMARY

The transaction clustering system disclosed herein includes systems, devices, and methods for, in real time or near-real time, identifying and classifying clusters of suspicious transactions with similar characteristics that may be difficult for a human to identify by inspection or simple filtering. Such clusters, and the classification data that sets them apart from other clusters and from the dataset as a whole, may be for more useful to fraud analysts than the classifications that are presently used. For example, a given cluster may represent twenty fraudulent transactions of the same type (e.g., stolen credit card numbers), regardless of the size or origin of the transaction. Sending these very similar alerts to the analyst may allow the analyst to respond to each one in a similar way, which may then serve to reduce context switching, improve throughput, and standardize resolution picking for similar kinds of alerts. Thus, the analyst may be more productive, and the analysis team may be able to handle a larger volume of suspicious transactions in a shorter period of time, with greater confidence in the results.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically analyze clusters of suspicious transactions. The system includes a processor and a computer readable medium operably coupled thereto, the computer readable medium including a plurality of instructions stored in association therewith that are accessible to, and executable by, the processor, to perform operations which include: receiving a plurality of risk factors; and receiving a plurality of suspicious transactions, where each transaction of the plurality of suspicious transactions includes a respective set of values for the risk factors of the plurality risk factors. The operations also include: with a clustering algorithm, based on the sets of values for the risk factors for the transactions of the plurality of transactions: generating a plurality of data clusters; assigning each transaction to a cluster of the plurality of data clusters; and for each cluster: for each risk factor of the plurality of risk factors, computing a respective cluster mean and cluster standard deviation of the risk factor values for the transactions assigned to the cluster; identifying risk factors of the plurality of risk factors for which the cluster standard deviation is below a respective threshold value for the risk factor; and generating a list of the identified risk factors and their respective cluster means and cluster standard deviations, ranked in relation to their respective cluster standard deviations. Other embodiments of this aspect include corresponding computer systems, apparatus, and computer programs recorded on one or more computer storage devices, each configured to perform the actions of the methods.

Implementations may include one or more of the following features. In some embodiments, the operations further include displaying the generated list, or a graphical representation thereof, to a user. In some embodiments, the operations further include initiating an automated action based on the generated list. In some embodiments, the automated action includes, as to one of the plurality of suspicious transactions, at least one of blocking the transaction, allowing the transaction, alerting a customer associated with the transaction, blocking a customer associated with the transaction, or suggesting a resolution action to a user. In some embodiments, the operations further include: for each respective risk factor in the plurality of risk factors, computing a full data mean and full data standard deviation of the values for the respective risk factor for each transaction of the plurality of suspicious transactions. In some embodiments, the respective threshold value for a respective risk factor is a function of the full data standard deviation for the respective risk factor, and where the generated list further includes the full data mean and full data standard deviation for each risk factor of the identified risk factors. In some embodiments, the respective threshold value for the respective risk factor is the full data standard deviation. In some embodiments, the plurality of risk factors includes at least one numerical risk factor and at least one categorical risk factor, and the clustering algorithm includes a K-prototype clustering algorithm. In some embodiments, the operations further include, when a current transaction of a cluster is selected by a user, suggesting a next transaction of the cluster to the user based on the respective values of the risk factors of the current transaction and next transaction. In some embodiments, the operations further include, when a current cluster is selected by a user, suggesting a next cluster to the user based on the respective cluster means of the risk factors of the current cluster and the next cluster. Implementations of the described techniques may include hardware, a method or process, or computer software on a computer-accessible medium.

One general aspect includes a computer-implemented method adapted to automatically analyze clusters of suspicious transactions. The computer-implemented method includes receiving a plurality of risk factors and a plurality of suspicious transactions, where each transaction of the plurality of suspicious transactions includes a respective set of values for the risk factors of the plurality risk factors. The method also includes, with a clustering algorithm, based on the sets of values for the risk factors for the transactions of the plurality of transactions: generating a plurality of data clusters; determining a cost function of the variation in values for each risk factor in the plurality of risk factors; by minimizing the cost function, assigning each transaction to a cluster of the plurality of data clusters; and for each cluster of the plurality of data clusters: for each risk factor of the plurality of risk factors, computing a respective cluster mean and cluster standard deviation of the risk factor values of the transactions assigned to the cluster; identifying risk factors of the plurality of risk factors for which the cluster standard deviation is below a threshold value; and generating a list of the identified risk factors and their respective cluster means and cluster standard deviations of their respective cost function, ranked in relation to their respective cluster standard deviations. Other embodiments of this aspect include corresponding computer systems, apparatus, and computer programs recorded on one or more computer storage devices, each configured to perform the actions of the methods.

Implementations may include one or more of the following features. In some embodiments, the method further includes displaying the generated list, or a graphical representation thereof, to a user. In some embodiments, the method further included initiating an automated action based on the generated list. In some embodiments, the automated action includes, as to one of the plurality of suspicious transactions, at least one of blocking the transaction, allowing the transaction, alerting a customer associated with the transaction, blocking a customer associated with the transaction, or suggesting a resolution action to a user. In some embodiments, the method further includes: for each respective risk factor in the plurality of risk factors, computing a full data mean and full data standard deviation of the values for the respective risk factor for each transaction of the plurality of suspicious transactions. In some embodiments, the threshold value for a respective risk factor is a function of the full data mean for the respective risk factor, and the generated list further includes the full data mean and full data standard deviation for each risk factor of the identified risk factors. In some embodiments, the threshold value for the respective risk factor is the full data standard deviation of the respective risk factor. In some embodiments, the plurality of risk factors includes at least one numerical risk factor and at least one categorical risk factor, and the clustering algorithm includes a K-prototype clustering algorithm. In some embodiments, the method further includes, when a current transaction of a cluster is selected by a user, suggesting a next transaction to the user based on the respective risk factors of the current transaction and next transaction. In some embodiments, the method further includes, when a current cluster is selected by a user, suggesting a next cluster to the user based on the respective cluster means of the risk factors of the current cluster and the next cluster. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the transaction clustering system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a representation, in block diagram form, of at least a portion of an example transaction clustering system, in accordance with at least one embodiment of the present disclosure.

FIG. 2 is a representation, in block diagram form, of at least a portion of an example transaction clustering system, in accordance with at least one embodiment of the present disclosure.

FIG. 3 is a representation, in block diagram form, of at least a portion of an example transaction clustering system, in accordance with at least one embodiment of the present disclosure.

FIG. 4 shows a flow diagram of an example key indicator preparation method that may be performed by the transaction clustering system, according to at least one embodiment of the present disclosure.

FIG. 5 shows a flow diagram of an example key indicator preparation method that may be performed by the transaction clustering system, according to at least one embodiment of the present disclosure.

FIG. 6 shows a flow diagram of an example key indicator preparation method that may be performed by the transaction clustering system, according to at least one embodiment of the present disclosure.

FIG. 7 shows a 2D plot of suspicious transactions organized into clusters, according to at least one embodiment of the present disclosure.

FIG. 8 shows statistical distributions of a risk factor in an identified cluster vs. the full dataset, according to at least one embodiment of the present disclosure.

FIG. 9 is a user interface display screen of an example transaction clustering system, according to at least one embodiment of the present disclosure.

FIG. 11 is a user interface display screen of an example transaction clustering system, according to at least one embodiment of the present disclosure.

FIG. 11 is a schematic diagram of a processor circuit, according to at least one embodiment of the present disclosure.

### DETAILED DESCRIPTION

In accordance with at least one embodiment of the present disclosure, an transaction clustering system is provided which automatically separates a dataset of suspicious transactions into clusters with distinctive characteristics, and identifies the most important characteristics of each cluster. The transaction clustering system may for example identify and classify clusters of suspicious transactions with similar characteristics that may be difficult for a human to identify by inspection or simple filtering. Such clusters, and the classification data that sets them apart from other clusters and from the dataset as a whole, may be for more useful to fraud analysts than the classifications that are presently used. For example, a given cluster may represent twenty fraudulent transactions of the same type (e.g., stolen credit card numbers), regardless of the size or origin of the transaction.

Sending these very similar alerts to the analyst may allow the analyst to respond to each one in a similar way, which may then serve to reduce context switching, improve throughput, and standardize resolution picking for similar kinds of alerts. Thus, the analyst may be more productive, and the analysis team may be able to handle a larger volume of suspicious transactions in a shorter period of time, with greater confidence in the results.

The system is programmed to identify a number of different risk factors, such as the account ID or routing number where a transaction originates, or whether this is the first identified transaction for that account ID or routing number. The risk factors can include both numerical risk factors and categorical risk factors. Several, several dozen, or several hundred different risk factors may be used by the system.

When the system receives a group of suspicious transactions (e.g., several dozen, several hundred, several thousand, or more transactions), each transaction includes values for at least some of the risk factors. The system then performs statistical analysis of these values across the group to identify clusters of transactions (e.g., subsets of the group with similar characteristics), and to identify and report at least some of the common characteristics that set each group apart from the other groups, and from the dataset as a whole, as described below.

For each transaction in the received group, the system can compute a cost function for each risk factor. Once all the cost functions have been determined, the system can compute a full data mean and a full data standard deviation for the cost functions of each risk factor, representing the statistical distribution of cost function values for that risk factor across the entire group of transactions.

The individual transactions can be treated as individual datapoints in a multidimensional space, where each risk factor is represented by a dimension. Thus, if 50 risk factors are considered, then each transaction can be represented as a point in a 50-dimensional space. With a suitable clustering algorithm (e.g., a K-prototype clustering algorithm that accounts for both numerical and categorical variables), the system can then identify data points that are close to one another within, and distant from the geometric center of, the multidimensional space. Anywhere from two to several dozen clusters may be identified, although in some cases the system may be most useful when the number of clusters is between 5 and 15 or, alternatively, when each cluster contains between 20 and 200 data points, although other numbers of clusters or data points, both larger and smaller, may be used instead or in addition. The selected algorithm may be configured so that every point in the dataset (e.g., every transaction in the total group) is assigned to a cluster.

Once the clusters have been identified, then for each transaction within a cluster, the system can compute the cost function. The system can then compute a cluster mean and a cluster standard deviation for the cost functions of each risk factor within the cluster, representing the statistical distribution for the cost function of that risk factor within the cluster. For a given risk factor, differences between the cluster distribution and the full data distribution can help to identify whether that particular risk factor is a significant or insignificant identifying trait for that particular cluster.

Thus, for each cluster the system can, for example, produce a list of risk factors whose cluster standard deviation falls below a threshold value, ranked in reverse order of the cluster standard deviation, such that the most tightly clustered risk factors are listed first. For each of the listed risk factors, the system can for example display the name of the risk factor, the cluster mean and cluster standard deviation of the risk factor, a comparison between the cluster mean and the full data mean, and a comparison between the cluster standard deviation and the full data standard deviation.

Alternatively or in addition, the system may display the transactions and clusters graphically. For example, the system may display a two-dimensional projection of the data points in the multidimensional space, where the X and Y axes are eigenvectors of the dataset. The data points in different clusters may, for example, be represented with different colors or different symbols, or the system may draw borders or approximate borders around each cluster. The list data for a given cluster, as described above, may then for example be displayed as a pop-up when a user clicks on a data point or transaction belonging to that cluster.

Thus, the clusters identified by the system represent groups of suspicious transactions with similar characteristics that can be recognized and understood, in real time or near-real time, such as by a fraud analyst. The transactions within a cluster may then for example be handled sequentially or as a group, with similar resolution methods that reduce the need for context switching and thereby potentially improve accuracy in detecting fraud. Context switching may then occur when the analyst switches to a different cluster, may not be required when handling the transactions of that different cluster.

The transaction clustering system can be used with existing fraud detection or anomaly detection systems, whether newly installed or already operational. As such, the transaction clustering system may improve the fraud detection processes, costs, workflows, and investigation times, for users of virtually any fraud detection system. Such potential users may include financial services companies, financial software vendors, banks, retailers, fraud detection firms, etc.

The present disclosure aids substantially in fraud detection by decreasing context switching, improving throughput, and reducing investigation times for fraud, while improving the ability of fraud investigators to adapt to changing criminal behavior in real time or near-real time. Implemented on a processor in communication with a memory structure or database, the system disclosed herein provides practical reductions in the time needed to clear a dataset of alerts. This improved throughput transforms a subjective, labor-intensive filtering process into a fast, accurate, repeatable, and resource-efficient clustering process that can be executed against stored transactions on demand, without the normally routine need to rely on the expertise of human fraud detection managers. This unconventional approach improves the functioning of the fraud detection computer system (e.g., an integrated fraud management computer system), by reducing the time lost to context switching on the part of system operators (e.g., fraud investigators).

The transaction clustering system may be implemented as a process at least partially viewable on a display, and operated by a control process executing on a processor that accepts user inputs from a keyboard, mouse, touchscreen interface, or the like, or any combination thereof, and that is in communication with one or more databases. In that regard, the control process performs certain specific operations in response to different inputs or selections made at different times. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the transaction clustering system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

The following terms will be used:
REDB Risk Engine Database, stores tenant model
RFDB Risk Feed Database, stores tenant events until it is closed
RADB Risk Application Database, stores tenant closed events
Risk Feed Utility component which moves data from the RFDB to the RADB
FA Fraud Analyst

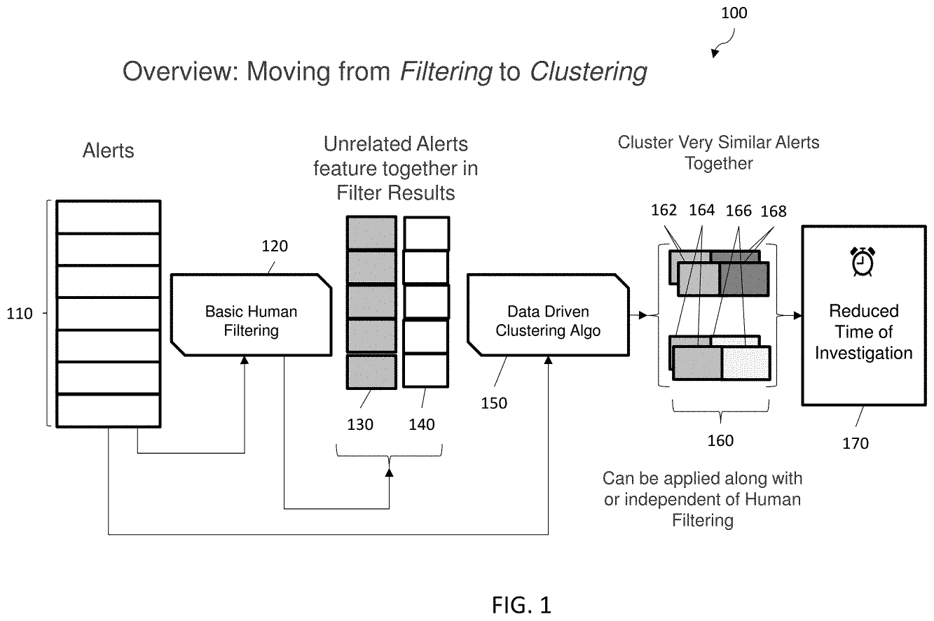

FIG. 1 is a representation, in block diagram form, of at least a portion of an example transaction clustering system 100, in accordance with at least one embodiment of the present disclosure. A dataset of alerts or suspicious transactions 110 is generated by a fraud detection system (e.g., a rule-based system, machine learning based system, or other system for detecting suspected fraudulent transactions) and received by the transaction clustering system 100. These alerts 100 generally go to a fraud manager at the bank who may then perform a human-mediated filtering step 120 to divide the alerts 100 into filtered groups (e.g., filtered groups 130 and 140), which can then be distributed amongst the fraud analysts working under the fraud manager This division may be done using simple filtering techniques. For example, alerts may be filtered based on the city that the alerts originate from or, in another example, sending a single analyst all the alerts with a high transaction amount. These simple filters may need to be updated often as the business climate changes.

Furthermore, the filtered results (e.g., filtered groups 130 and 140) may each be collections related to different types of fraud. For example, the set of alerts from a particular city may include an online romance scam as well as a money mule scheme. The analyst may then need to then go through these varied types of alerts and, for example, call the client to confirm the payment they made versus filing a SAR report versus just escalating the fraud alert for greater scrutiny. This may require continuously context switching, which may interfere with a streamlined alert solution pipeline. Further, the resolutions for similar frauds, even for the same analyst, may not be standardized if they are not solved together.

The transaction clustering system 100 of the present disclosure, instead of (or in addition to) relying on simple human filtering 120 to divide fraud alerts amongst analysts, uses complex data, including various risk factors. On this rich data, the system deploys data clustering techniques (e.g., a data-driven clustering algorithm 150) to create multiple “clusters” 160 of transactions falling within similar risk areas. In the example shown in FIG. 1, the clusters 160 include a first cluster 160 including transactions 162 of a first type, a second cluster 160 including transactions 164 of a second type, a third cluster 160 including transactions 166 of a third type, and a fourth cluster 160 including transactions 168 of a fourth type.

Sending these clusters 160 (each containing very similar alerts) to an analyst may significantly reduce context switching, improve throughput, and standardize resolution choices for similar kinds of alerts, thus resulting in reduced investigation times 170.

The transaction clustering system 100 may for example be programmed to identify a number of different risk factors, such as the account ID or routing number where a transaction originates, or whether this is the first identified transaction for that account ID or routing number. The risk factors can include both numerical risk factors and categorical risk factors. Several, several dozen, or several hundred different risk factors may be used by the system.

When the transaction clustering system 100 receives a group of suspicious transactions (e.g., several dozen, several hundred, several thousand, or more transactions), each transaction may include values for at least some of the risk factors. The transaction clustering system 100 may then perform statistical analysis of these values across the group to identify clusters of transactions (e.g., subsets of the group with similar characteristics), and to identify and report at least some of the common characteristics that set each group apart from the other groups, and from the dataset as a whole, as described below.

When solving an alert, some existing systems permit a user to manually create or refine a search query, using simple human readable filters, to find “similar” alerts to the one that is currently being solved. However, the transaction clustering system 100 of the present disclosure does not require human intervention or human-constructed queries or filters to generate clusters of similar alerts. The transaction clustering system 100 thus represents a significant improvement over existing systems.

It is noted that block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

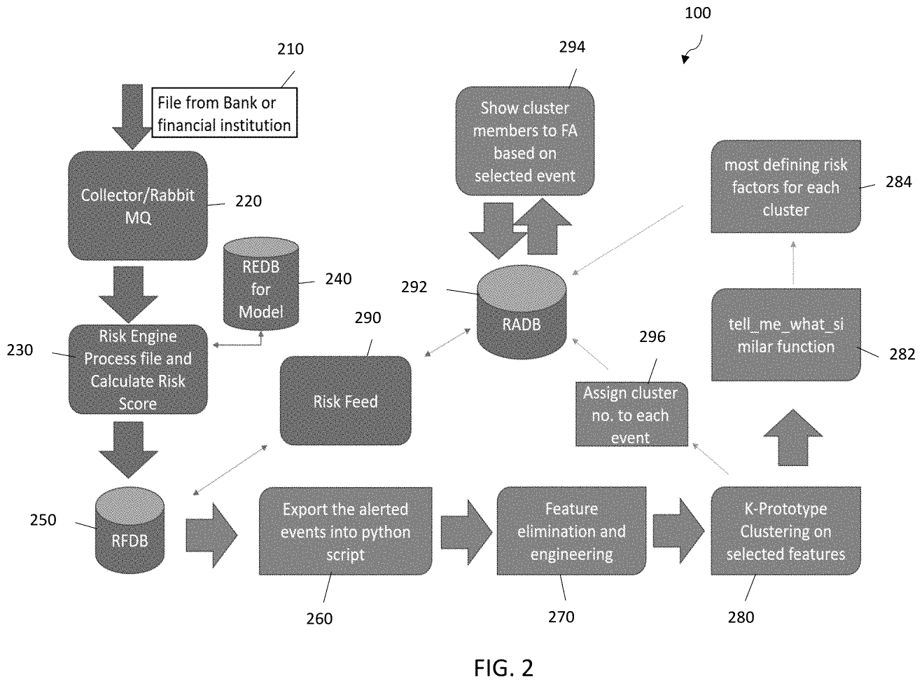

FIG. 2 is a representation, in block diagram form, of at least a portion of an example transaction clustering system 100, in accordance with at least one embodiment of the present disclosure. In the example shown in FIG. 2, the transaction clustering system 100 receives a file or collection of files 210 that contain the values of risk factors (e.g., transaction variables) that describe each alert or suspicious transaction. The file or files 210 are received into a collector message queue 220, which passes them to a risk engine 230. The risk engine 230 also receives information from a Risk Engine Database (REDB) 240 which stores a model for computing risk. Based on the REDB 240 and the information contained in the file 210, the risk engine 230 calculates values such as a risk score, which are then passed to a Risk Feed Database (RFDB), which stores them as events. The events are then exported into a script 260 (e.g., a Python script), which performs a simplification step 270 to eliminate redundant or statistically insignificant features. The simplified list of events is then received into the clustering algorithm 280, which performs clustering (e.g., K-prototype clustering) on selected features of the events. The resultant clusters are then passed to a “tell me what's similar” function 282, which identifies, for each cluster, the risk factors that most contribute to the uniqueness of that cluster. These values may then be passed to a Risk Application Database 292, which stores closed events (e.g., suspicious transactions that have been resolved by a risk analyst).

In some embodiments, events from the RFDB 250 are also passed to a risk feed 290, and stored in the RADB 292 when completed. In some embodiments, a secondary clustering step 296 assigns a cluster number to each event (e.g., to each suspicious transaction in the simplified list), and stores these in the RADB 292. An output step 294 may also display or otherwise communicate the cluster number of a given event, alert, or suspicious transaction, as well as information about the cluster, to the fraud analyst working on that particular event, alert, or transaction.

Efficiency of the analyst is a key business metric to optimize for in the compliance industry. With the transaction clustering system 100 of the present disclosure, most of the alerts in an analyst's queue are likely to be similar. Thus, the analyst may not need to spend as much time in identifying fraudulent alerts, as they would using current systems. This is likely to improve the efficiency of Fraud Desk Analysts, at least in terms of both time and cost. With current systems, managers may be required to maintain an analyst's alert queue, and this may require constant updating of simple human readable filters. Conversely, the transaction clustering system 100 can automatically assign very similar alerts to individual analysts, thus reducing the need for manual intervention during this division of labor.

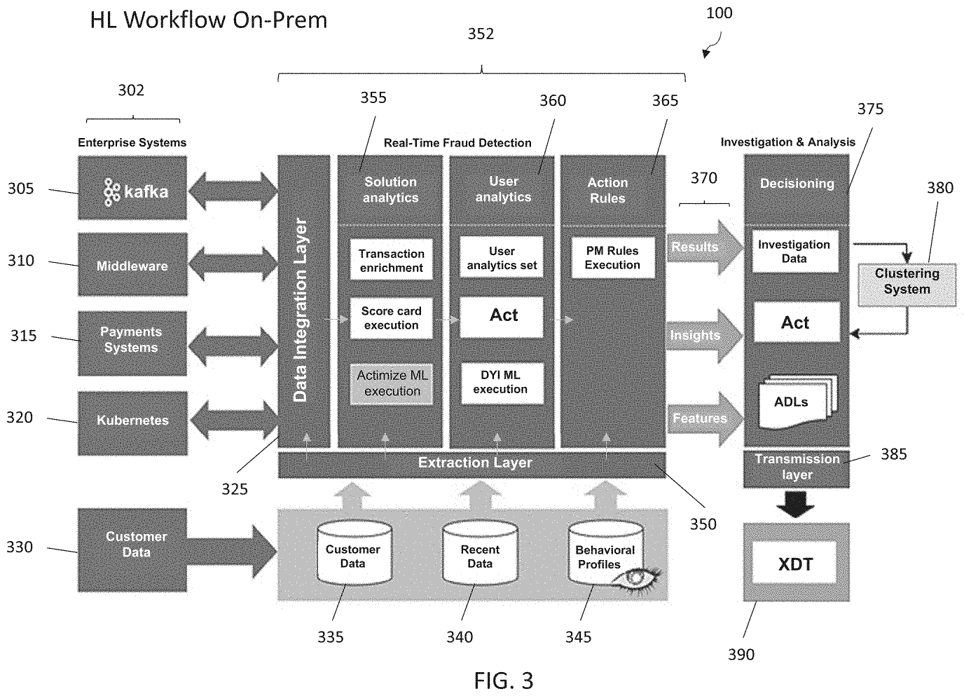

FIG. 3 is a representation, in block diagram form, of at least a portion of an example transaction clustering system 100, in accordance with at least one embodiment of the present disclosure. In the example shown in FIG. 3, the transaction clustering system 100 includes enterprise systems 302, which can include but are not limited to a data streaming pipeline 305 (e.g., Apache Kafka), middleware 310, payments systems 315, and a container management system 320 (e.g., Kubernetes). The enterprise systems 302 can exchange information with a data integration layer 325 of a real-time or near-real-time fraud detection system 352.

Customer data 330 may then be received into a customer data database 335, a recent data database 340, and a behavioral profiles database 345, each of which communicates with an extraction layer 350 of the fraud detection system 352. Both the data integration layer 325 and the extraction layer 350 may pass data to a solution analytics subsystem 355 of the fraud detection system 352. The solution analytics subsystem 355 may for example perform such tasks as transaction enrichment, score card execution, and execution of a first machine learning algorithm, which collectively help to define risk scores for the suspicious transactions. The solution analytics subsystem 355 may then pass the risk-scored transactions to a user analytics subsystem 360, which may for example perform such tasks as setting user analytics, operating an Analytics Authoring Environment (e.g., AAE, a tool for creating policies, rules and fraud detection pipelines), and execution of a second machine learning algorithm, which collectively create a comprehensive risk profile for each user account. The user analytics subsystem 360 may then pass the risk scored transactions (now enhanced by the user risk profile analytics) to an action rules subsystem 365, which may for example execute rules that identify potentially fraudulent transactions from the complete set of input transactions. It is noted that formatted or processed customer data from the extraction layer 350 may be passed into any of the data integration layer 325, solution analytics subsystem 355, user analytics subsystem 360, or action rules subsystem 365, as part of the processing operations described above.

The fraud detection system 352 may then, in real time or near-real time, pass alerts 370 (e.g., transactions that are deemed suspicious) to an investigation and analysis system 375. The alerts 370 may for example include analysis results, insights and features (e.g., values of the various risk factors) that have been generated or extracted by the fraud detection system 352. The investigation and analysis subsystem may for example organize investigation data, manage transaction alerts and pick resolutions (e.g., via Nice Actimize ActOne), and record or manage detection logs (e.g., Actimize Detection Logs or ADLs), in order to provide alerted transactions to the fraud investigation team. In some embodiments, the Investigation and analysis system 375 may pass the alerted transactions to a clustering system 380, such that similar transactions are grouped together for the convenience of fraud analysts, as described above. The alerted transactions, thus organized, can then be passed to a transmission layer 385, which transmits them to a data transporter 390 (e.g., Actimize X-sight Data Transporter or XDT) capable of transporting data to or from cloud storage or other storage.

The process or workflow shown in FIG. 3, reduces effort on policies and filters by automatically organizing suspicious transactions into clusters, where each cluster represents transactions with identifiable characteristics that set it apart from the other clusters, and from the full dataset. This in turn may increase the throughput of the fraud analysis team, and suggest quick resolutions for suspicious transactions of similar type. In some embodiments, the transaction clustering system 100 may suggests resolutions for transactions of a recognizable type (e.g., recognized with a rule-based, machine learning, or pattern recognition algorithm).

One aim of the present disclosure is to reduce the efforts of fraud analysts by assigning similar alerts to one analyst and to display the alerts in an order that maximizes similarity and thus reduces context switching. This may be accomplished, for example, by automatically filtering the alerts and grouping them to show close to similar alerts in fraud analyst queue by making the use of clustering algorithm based on various risk factors. Alerts belonging to the same cluster may have similar behavioral patterns in terms of perceived fraud. The algorithms described herein can be fully automated, and can make use of risk factors that are not easily readable or interpretable by a human analyst, e.g., those that require evaluating a substantial number of clusters that cannot be timely analyzed by a person.

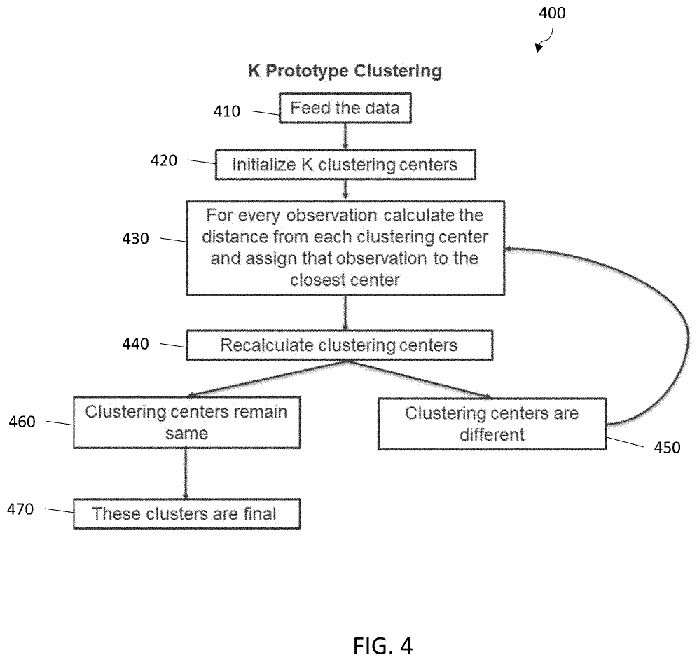

FIG. 4 shows a flow diagram of an example key indicator preparation method 400 that may be performed by the transaction clustering system 100, according to at least one embodiment of the present disclosure. Algorithms used in the transaction clustering system 100 can for example be shown or described as decision diagrams.

In step 410, the method 400 includes feeding or organizing the data associated with a dataset of suspicious transactions. This may for example include data pre-processing and data preparation of transactions stored in a database. In an example, the database includes rich, complex risk factors of mixed type, e.g., with numeric as well as categorical data. In an example, step 410 may include preprocessing the risk factors associated with the suspicious transactions, to remove any null values and to label the risk factors according to numerical and categorical (both binary and multinomial) data types. The numerical data may then be standardized (e.g., normalized) using the StandardScalar function in sklearn-python.

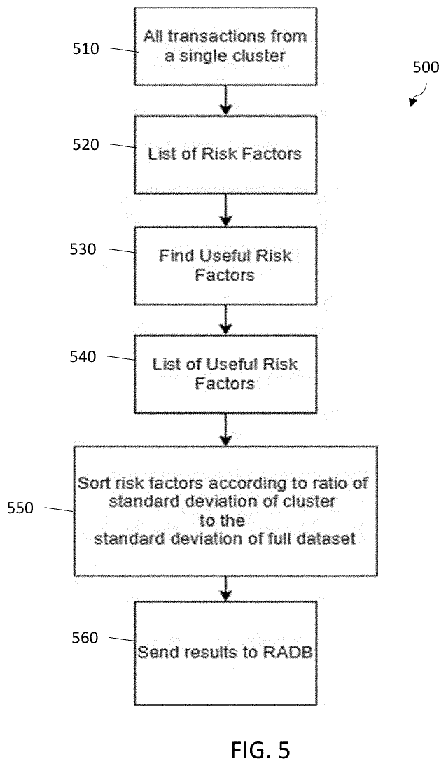

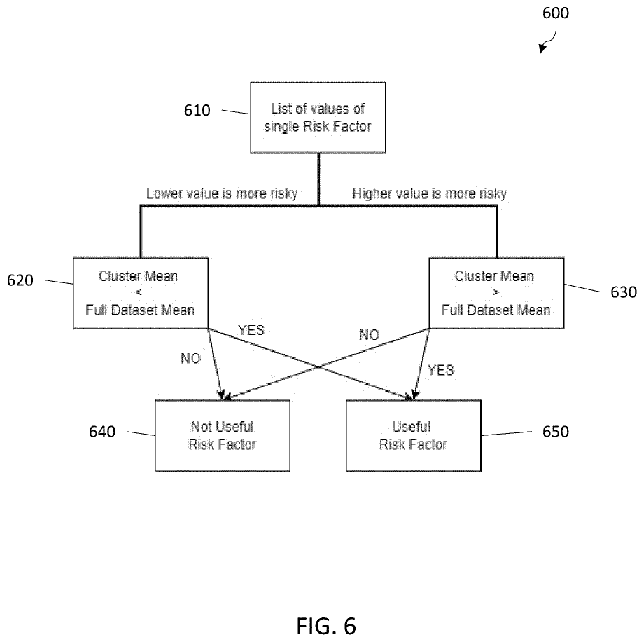

In an example, the method 400 makes use of two main algorithms: K-Prototype Clustering and our in-house developed function the “tell_me_whats_similar” function (described below in FIGS. 5 and 6), although other algorithms may be used instead or in addition that produce the results described herein.

In step 420, the feature-engineered results from step 410 serve as input to the clustering algorithm (e.g., a K-Prototype Clustering algorithm). Cluster center initialization may be performed at this step, e.g., with an initialization method such as “Huang” initialization.

In step 430, the K-Prototype Clustering algorithm, for both numeric and categorical variables, uses a dissimilarity function to calculate a proxy for the distance between two observations. Based on the dissimilarity function, it processes the “closest” transactions into clusters. Some embodiments may for example employ the “K modes” package in python to perform K prototype clustering on the dataset of suspicious transactions, which may be represented using mixed types risk factors. To automate the selection of optimized number of clusters, the algorithm may for example use the elbow method, which divides the data into clusters and for each transaction/observation outputs a number representing the cluster to which that transactions belongs. One possible embodiment employs risk elements of each alert X and Y shown as xⱼ, yⱼ below.

The dissimilarity function d₂ may for example have the following formulation:

d₂(X,Y)=Σⱼ₌₁^{p}(xⱼ−yⱼ)²+γΣⱼ₌ₚ₊₁^{m}δ(xⱼ,yⱼ) (EQ. 1)

One benefit of this technique to the present disclosure is in the dissimilarity function being broken down into a Euclidean distance for real-valued variable pairs, or into a δ representing a nondimensional “distance” for categorical variable pairs. A weighted mean can be taken between the two using a weight γ to balance the two parts, to avoid favoring one type of attribute over the other type. In this example, (xⱼ, yⱼ j=1, . . . , p, p+1, . . . , m) represents the m variables corresponding to ith alert.

The clusters are formed in such a way that the cost function given below is minimized.

P(W,Q)=Σₗ₌₁^{k}(Pₗ^{r}+Pₗ^{c}) (EQ. 2)

Where W is an n×k partition matrix and Q is set of objects in the same object domain, and here, P^{r} and P^{c} represent the cost functions of real-number-valued and categorical variables, respectively, k represents the total number of clusters to be formed, q represents one element of Q, and l is a running variable representing cluster number, used for summation over all clusters. Thus:

Pₗ^{r}=Σᵢ₌₁ⁿw_{i,l}Σⱼ₌₁^{p}(x_{i,j}−q_{l,j})² (EQ. 3)

Pₗ^{c}=γΣᵢ₌₁ⁿw_{i,l}Σⱼ₌ₚ₊₁^{m}δ(x_{i,j},q_{l,j}) (EQ. 4)

Some possible examples of non-human-filterable risk factors (e.g., risk factors not easily read or interpreted by a human fraud investigator) include:
new_SEC_q (an indicator of whether this SEC code with this transaction (trx) type (excluding misc_trx_code) has been seen before for this recipient).

CombinedAmountRisk (an indicator of risk associated with the actor transferring a suspiciously large amount, given s/he has never transferred such a large amount before).
unique_iat_orig_within_country (the number of unique originators with IAT code and within this country for this recipient).
iat_country_trx_count (the number of transactions (trx) with this IAT originator's country for this recipient).
cnx_trxtype_num_occur (the number of trx with this trx type for this cnx (recipient & originator)).

Some embodiments include 50 or more risk factors associated with each transaction, although other embodiments may use more or fewer risk factors, including such values as 5, 10, 25, 100, 300, or more.

In step 440, the method includes recalculating the clustering centers (e.g., the cluster's mean value for each risk factor).

In step 450, the method includes detecting that the cluster centers have moved from the previous iteration (e.g., are different by more than a specified threshold amount for one or more risk factors). Execution then returns to step 430 for another iteration.

In step 460, the method includes detecting that the cluster centers have not moved from the previous iteration (e.g., are not different by more than a specified threshold amount for any of the risk factors). Execution then proceeds to step 470.

In step 470, the method is complete, and the generated clusters may be considered final.

It is noted that flow diagrams are provided herein for exemplary purposes; a person of ordinary skill in the art will recognize myriad variations that nonetheless fall within the scope of the present disclosure. For example, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, generating clusters of suspicious transactions may require processing dozens risk factors for each of hundreds or thousands of suspicious transactions, according to the equations described above, in a real-time or near-real-time flow that does not require a fraud investigation team to sit idle while waiting for the clustering results.

FIG. 5 shows a flow diagram of an example key indicator preparation method 500 that may be performed by the transaction clustering system 100, according to at least one embodiment of the present disclosure. The key indicator preparation method 500 may for example be, include, or be a part of a “tell me what's similar” function that helps a user identify the important characteristics of a given cluster, which may provide cues as to which type of fraud the cluster represents, as described below, and may sort the selected risk factors by the “tightness” of their score distribution when compared to the full dataset. A given risk factor may be considered “useful”, “significant”, or “important” for the definition of a given cluster if the standard deviation of the risk factor for the lesser in the cluster is less than the standard deviation of that same risk factor for the full dataset, or is less by more than a specified, risk-factor-specific threshold amount. Thus, the method includes, for each risk factor, calculating a full dataset standard deviation, as well as a cluster standard deviation for each cluster in which the risk factor appears.

In step 510, the method includes receiving all of the transactions from a single cluster.

In step 520, the method includes assembling a list of risk factors found within the cluster.

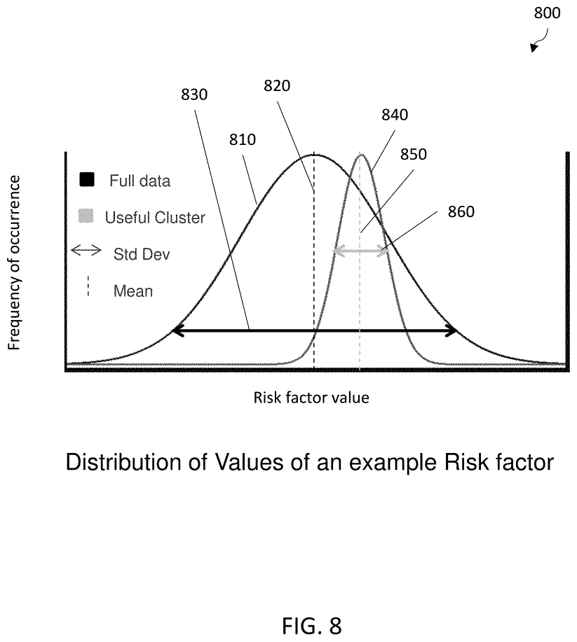

In step 530, the method includes finding the useful, important, or significant risk factors for the cluster, as described below in FIG. 8. A given risk factor may be considered “useful”, “significant”, or “important” for the definition of a given cluster if the standard deviation of the risk factor for the lesser in the cluster is less than the standard deviation of that same risk factor for the full dataset, or is less by more than a specified, risk-factor-specific threshold amount. Thus, step 530 may include, for each risk factor, calculating a full dataset standard deviation, as well as a cluster standard deviation for the cluster currently being examined

It is noted that for categorical (non-numeric) risk factors, the mean and/or standard deviation may be based on mode values (e.g., the most frequently observed value for that risk factor).

In step 540, the method includes assembling a list of the useful, important, or significant risk factors for the cluster.

In step 550, the method includes sorting the list of useful, important, or significant risk factors according to their importance. This may be done, for example the ratio of the cluster standard deviation to the full dataset standard deviation for each risk factor, such that the risk factor with the lowest ratio is ranked most important, and the risk factor with the highest ratio is considered least important. Other sorting mechanisms may be used instead or in addition, to produce an importance-ordered list of the risk factors that set the current cluster apart from other clusters, and from the full dataset.

In step 560, the method includes passing the importance-ordered list to the Risk Application Database (RADB) for later display to the user. This exemplary method is now complete.

FIG. 6 shows a flow diagram of an example key indicator preparation method 600 that may be performed by the transaction clustering system 100, according to at least one embodiment of the present disclosure. In some embodiments, the risk factor may, instead or in addition to standard deviation ranking, be considered significant or important (e.g., riskier than average) if the mean of the risk factor is different for the cluster than for the full dataset. In an example, a risk factor may be statistically significant for defining a particular cluster (e.g., may have a smaller cluster standard deviation than full dataset standard deviation), but still be unimportant or non-useful in the sense that the cluster values for that risk factor do not represent a higher-than-average risk. It may then be desirable to exclude or remove such risk factors from any importance-ordered list of risk factors.

Thus, in step 610, the method 600 includes receiving a list of values for a single risk factor within the current cluster. In some embodiments, step 610 may also include, for a selected risk factor of the current cluster, calculating a full dataset standard mean, as well as a cluster mean for the current cluster.

If the current risk factor is defined such that a lower value is considered more risky than a higher value (e.g., a credit score associated with the transaction), execution then proceeds to step 620. Alternatively, if the current risk factor is defined such that a higher value is considered riskier than a lower value (e.g., a dollar amount of the transaction over the transactor's credit limit), execution then proceeds to step 630.

In step 620, the method 600 includes determining whether, for the current risk factor, the cluster mean is less than the full dataset mean by a specified threshold amount (e.g., 0%, 5%, 10%, etc.) If no, execution proceeds to step 640. If yes, execution proceeds to step 650.

In step 630 the method 600 includes determining whether, for the current risk factor, the cluster mean is greater than the full dataset mean by a specified threshold amount (e.g., 0%, 5%, 10%, etc.) If no, execution proceeds to step 640. If yes, execution proceeds to step 650.

In step 640 the method 600 includes determining that the current risk factor is not useful, important, or significant. For the current risk factor and the current cluster, the method 600 is now complete.

In step 650 the method 600 includes determining that the current risk factor is indeed useful, important, or significant. For the current risk factor and the current cluster, the method 600 is now complete.

In some embodiments, via a similar process, risk factors may, instead or in addition, be ranked or excluded from ranking according to their interpretability. Thus, a risk factor that is easy for a human analyst to interpret may be included in the ranking, or may be ranked higher, whereas a risk factor that is difficult for a human analyst to interpret may be ranked lower, or may be excluded from the ranking altogether, as it may not provide useful cues to the analyst as to how to resolve that type of suspicious transaction.

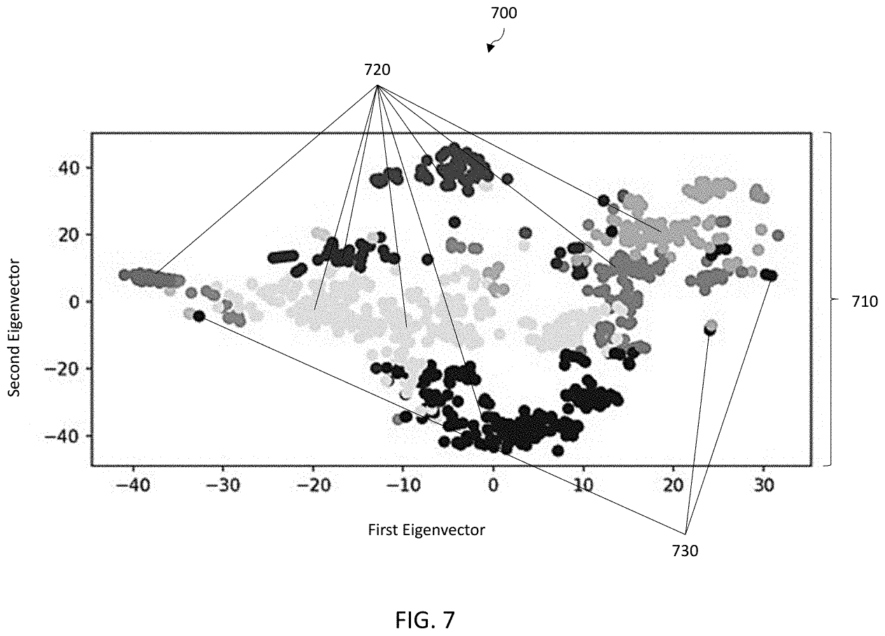

FIG. 7 shows a 2D plot 700 of suspicious transactions 710 organized into a plurality of clusters 720 (each represented by a different color), according to at least one embodiment of the present disclosure.

The individual transactions 710 can be treated as individual datapoints in a multidimensional space, where each risk factor is represented by a dimension. Thus, if 50 risk factors are considered, then each transaction can be represented as a point in a 50-dimensional space. In some embodiments, clear, well-separated clusters may be considered more useful to the fraud analyst. Thus, the 2D plot 700 may represent a particular two-dimensional “shadow” of the 50-dimensional space, wherein the separation between clusters or datapoints is maximized This may be accomplished for example if the X and Y axes of the two-dimensional shadow are eigenvectors of the dataset in the 50-dimensional space.

With a clustering algorithm (e.g., a K-prototype clustering algorithm that accounts for both numerical and categorical variables), the system can then identify data points (e.g., transactions 710) that are close to one another within, and distant from the geometric center of, the multidimensional space. Anywhere from two to several dozen clusters may be identified, although in some cases the system may be most useful to the fraud analysis team when the number of clusters is between 5 and 15 or, alternatively, when each cluster contains between 20 and 200 data points, although other numbers of clusters or data points, both larger and smaller, may be used instead or in addition. The algorithm is configured so that every point in the dataset (e.g., every transaction 710 in the total group) is assigned to a cluster.

Thus, for each cluster 720 the system can for example, produce a list of risk factors whose cluster standard deviation falls below a threshold value, ranked in reverse order of the cluster standard deviation, such that the most tightly clustered risk factors are listed first. For each of the listed risk factors, the system can for example display the name of the risk factor, the cluster mean and cluster standard deviation of the risk factor, a comparison between the cluster mean and the full data mean, and a comparison between the cluster standard deviation and the full data standard deviation.

The data points in different clusters may for example be represented with different colors, different shading, different symbols, etc., or the transaction clustering system 100 may draw borders or approximate borders around each cluster, with certain outliers 730 possibly falling outside the drawn borders. The clusters may be marked in still other ways as would occur to a person of ordinary skill in the art. The list data for a given cluster 720, as described above, may then for example be displayed as a pop-up when a user clicks on a data point or transaction 710 belonging to that cluster 720.

Thus, the clusters 720 identified by the system represent groups of suspicious transactions 710 with similar characteristics that can be recognized and understood, in real time or near-real time, by a fraud analyst. The transactions within a cluster 720 may then for example be handled sequentially or as a group, with similar resolution methods that reduce the need for context switching. Context switching may be further minimized if, after analyzing a given transaction 710 within a cluster 720, the fraud analyst then selects, as the next transaction 710 to analyze, the transaction that is “closest” to the previous transaction in the multidimensional space or two-dimensional shadow. In some embodiments, the next closest data point is recommended automatically.

Context switching may then occur when the analyst switches to a different cluster. However, even in this case, context switching may be minimized if the next cluster is “close” to the previous cluster in the multidimensional space or in the 2D shadow. In some embodiments, when a fraud analyst has finished analyzing all the transactions 710 of a given cluster 720, the system automatically suggests the next closest cluster 720, and may additionally suggest the transaction 710 within that cluster that is closest to the last transaction analyzed by the fraud analyst. Thus, the transaction clustering system 100 provides methods for dramatically reducing context switching, and may thus improve the efficiency and throughput of the fraud analyst in analyzing transactions and detecting fraud.

FIG. 8 shows a statistical distribution plot 800 of a risk factor in an identified cluster vs. the full dataset, according to at least one embodiment of the present disclosure. In the example shown in FIG. 8, the X-axis of the statistical distribution plot 800 represents the values of a given risk factor, while the Y-axis represents the frequency of occurrence for each value. The statistical distribution plot 800 shows a full dataset distribution 810, a full data mean 820, and a full data standard deviation 830. The statistical distribution plot 800 also shows a distribution 840 for a particular cluster, along with a cluster mean 850 and a full data standard deviation 860. Depending on the implementation, useful or important risk factors within a cluster may tend to have cluster means significantly different from the full data mean, and cluster standard deviations significantly smaller from the full data standard deviation (e.g., tighter grouping).

It may be useful for the transaction clustering system 100 to help the fraud managers, as well as analysts, understand why the transactions in a particular cluster were clustered together. In some embodiments, this may be accomplished with a tell_me_whats_similar function, whose inputs are the transactions in a given cluster. The function can be explained as a two-step approach that sorts the risk-factors being used for cluster creation in the order of importance to the formation of the cluster as well as to the interpretability of the clustering result. For a given risk factor, differences between the cluster distribution and the full data distribution can help to identify whether that particular risk factor is a significant or insignificant identifying trait for that particular cluster.

For example, for each risk factor, the system may calculate the ratio of standard deviation (stddev) of cluster to the standard deviation for the full dataset. The risk factors with stddev_ratio<1 mean that the spread of risk factor reduces after clustering, hence those are vital in forming the cluster. Similarly, higher risk factor values signify a more risky transaction in that particular factor's purview, hence, clusters with cluster_mean>full_data_mean for risk factors may be considered riskier as described above.

These two conditions may provide useful cluster information to the fraud analyst.

Example code to execute the “tell me what's similar” fuction may include:

cluster_number = 9
t = tell_me_whats_similar(to_train, clusters = clusters,
cluster_number = cluster_number)
t.query(“mean_cluster>mean_full”)

Example code for the “tell me what's similar function” itself may include:

```
def tell_me_whats_similar(full_df, clusters, cluster_number, himr,
limr):
# “““
# “full_df” represents the dataset with rows as transactions and columns
as risk factors
# “clusters” is a list of cluster numbers assigned to each transaction
# “cluster_number” is a particular cluster number being explored by the
tell_me_whats_similar function
# “himr” is a list of risk factors for which a larger value means a more
risky transaction
# “limr” is a list of risk factors for which a smaller value means a more
risky transaction
# returns: Sorted list of risk factors in the order of importance to the
formation of the cluster
# as well as the interpretability of the clustering result for the risk analyst
# ”””
  column_names = himr + limr
  # Get mean and std deviation of full dataset
  std_full = full_df[column_names].std( )
  mean_full = full_df[column_names].mean( )
  # Get mean and std deviation of cluster members only
  cluster_df = full_df[clusters==cluster_number]
  std_cluster = cluster_df[column_names].std( )
  std_ratio = std_cluster/std_full
  mean_cluster = cluster_df[column_names].mean( )
  # Apply mean based selection
  to_return = pd.concat([mean_cluster, std_cluster, mean_full,
  std_full, std_ratio], axis=1)
  to_return.columns = [“mean_cluster”, “std_cluster”,
  “mean_full”, “std_full”, “std_ratio”]
  to_return_himr = to_return.loc[himr]
  to_return_limr = to_return.loc[limr]
  to_return_himr = to_return_himr.query(“mean_cluster >
  mean_full”)
  to_return_limr = to_return_limr.query(“mean_cluster < mean_full”)
  to_return = pd.concat([to_return_himr, to_return_limr], axis=0)
  # Apply std based sorting
  to_return = to_return.sort_values(“std_ratio”)
  return to_return
```

Example output for the “tell me what's similar” function may include:

TABLE 1
Example “tell me what's similar” output

| | mean_cluster | std_cluster | mean_full | std_full | std_ratio |
|---|---|---|---|---|---|
| CombinedLocationRisk | 3.629000 | 0.829898 | 3.583455 | 0.842264 | 0.985318 |
| unique_iatcountry | 0.389831 | 0.877388 | 0.098976 | 0.703384 | 1.247383 |
| CombinedAmountRisk | 0.384644 | 0.505619 | 0.287018 | 0.388744 | 1.300646 |
| cnx_num_occur | 4.194915 | 18.986391 | 2.121729 | 11.078822 | 1.713755 |
| quantifier | 38983.1336 | 91320.9178 | 11676.8502 | 53265.1736 | 1.714748 |

The output of the tell_me_whats_similar function may thus be a prioritized list of representative risk factors that help interpret the clustering in the context of Fraud Analysis. A sample tenant's data may include event attributes contained in the event_dump column of the ga_rf_event_history table of the database.

### Sample Information

Host: db-09-3.alg.dc1.fm-hosted.com
DB Schema: eli_mod433_amerant_rdfi_100p
Table: ga_rf_event_history
Sample tenant: Amerant RDFI data
Percent of data used: 100%
Event Attributes/Features/Variables details:

TABLE 2
Example risk factors that may be used to represent a transaction

| variable_name | data_type | source_type | variable_description |
|---|---|---|---|
| actor | category | primary | user/actor account id, the |
| | | | recipient |
| rdfi_id | category | primary | Receiving Depository |
| | | | Financial Institution |
| | | | routing number |
| odfi_id | category | primary | Originating Depository |
| | | | Financial Institution |
| | | | routing number |
| originator | category | primary | originator account id |
| sec_code_copy | category | primary | original sec code of the |
| | | | transaction |
| company_name | category | primary | originator account name |
| company_entry_description | category | primary | originator description of |
| | | | the transactions |
| known_origin_q | bool | secondary | whether event done with a |
| | | | new originator id first |
| | | | time by transaction type |
| full_known_origin_q | bool | secondary | whether event done with a |
| | | | new originator id first day |
| | | | by transaction type |
| paypalflag | bool | secondary | is this a Paypal transaction |
| known_origin_company_name_q | bool | secondary | whether event done with a |
| | | | new originator id & name |
| | | | first time by transaction |
| | | | type |
| full_known_origin_company_name_q | bool | secondary | whether event done with a |
| | | | new originator id & name |
| | | | first day by transaction |
| | | | type |
| new_orig_alltype_indicator | bool | secondary | whether event done with a |
| | | | new originator id first day |
| | | | (regardless transaction |
| | | | type) |
| new_rec_name_indicator | bool | secondary | whether event done with |
| | | | an originator calling actor |
| | | | a new name |
| rec_num_occur | int64 | secondary | number of events has done |
| | | | for each actor before |
| | | | current event |
| cnx_num_occur | int64 | secondary | number of events has done |
| | | | for each actor, originator |
| | | | pair before current event |
| rec_trxtype_num_occur | int64 | secondary | number of events (by |
| | | | transaction type) has done |
| | | | for each actor before |
| | | | current event |
| rec_name_num_occur | float64 | secondary | number of times such |
| | | | recipient name has |
| | | | occurred before current |
| | | | event |
| cnx_trxtype_num_occur | float64 | secondary | number of events (by |
| | | | transaction type) has done |
| | | | for each actor, originator |
| | | | pair before current event |
| rec_companyname_trxtype_num_occur | int64 | secondary | number of events has |
| | | | occurred for this actor, |
| | | | originator (by name) pair |
| | | | by transaction types |
| | | | before current event |
| rec_trxtype_withinday_new_orig_num_occur | float64 | secondary | number of events has |
| | | | occurred for this actor, |
| | | | new originator id pair by |
| | | | transaction types before |
| | | | current event in the same |
| | | | day |
| rec_trxtype_withinday_new_rec_name_num_occur | float64 | secondary | number of events has |
| | | | occurred for new recipient |
| | | | name being called by this |
| | | | new originator id by |
| | | | transaction types before |
| | | | current event in the same |
| | | | day |
| cleanindividualname | category | secondary | the clean individual name |
| | | | actor being called by the |
| | | | originator |
| num_uniq_indivname | int64 | secondary | number of unique |
| | | | individual names being |
| | | | called for each actor |
| num_uniq_cleanindivname | int64 | secondary | number of clean |
| | | | individual name of the |
| | | | actor |
| count_new_rec_name_3 | int64 | secondary | number of new recipient |
| | | | names the actor being |
| | | | called has occurred in the |
| | | | last 3 days include current |
| | | | event |
| count_new_rec_name_7 | int64 | secondary | number of new recipient |
| | | | names the actor being |
| | | | called has occurred in the |
| | | | last 7 days include current |
| | | | event |
| count_new_rec_name_1m | int64 | secondary | number of new recipient |
| | | | names the actor being |
| | | | called has occurred in the |
| | | | last one month including |
| | | | current event |
| new_sec_q | bool | secondary | whether the event is |
| | | | associated with an |
| | | | sec_code type the actor |
| | | | has never done before |
| unique_sec_count | category | secondary | number of time such sec |
| | | | code type has occurred for |
| | | | the actor by transaction |
| | | | type |
| company_unique_rec_count | int64 | secondary | number of unique actors |
| | | | this originator name has |
| | | | done transaction with |
| originator_unique_rec_count | int64 | secondary | number of unique actors |
| | | | this originator id has done |
| | | | transaction with |
| quantifier | float64 | primary | dollar amount of the event |
| count_new_orig_alltype_1 | int64 | secondary | number of new originator |
| | | | id the actor has done |
| | | | transaction with in the last |
| | | | 1 day include current |
| | | | event |
| count_new_orig_alltype_3 | int64 | secondary | number of new originator |
| | | | id the actor has done |
| | | | transaction with in the last |
| | | | 3 day include current |
| | | | event |
| count_new_orig_alltype_7 | int64 | secondary | number of new originator |
| | | | id the actor has done |
| | | | transaction with in the last |
| | | | 7 day include current |
| | | | event |
| count_new_orig_alltype_1m | int64 | secondary | number of new originator |
| | | | id the actor has done |
| | | | transaction with in the last |
| | | | 1 month include current |
| | | | event |
| rec_debit_max_amount | float64 | secondary | the maximum dollar |
| | | | amount the actor has done |
| | | | debit transaction with |
| debit_cnx_max_amount | float64 | secondary | the maximum dollar |
| | | | amount the actor has done |
| | | | debit transaction with this |
| | | | originator id |
| debit_reccomp_max_amount | float64 | secondary | the maximum dollar |
| | | | amount the actor has done |
| | | | debit transaction with this |
| | | | originator name |
| unique_iat_orig_within_country | float64 | secondary | number of unique |
| | | | originations the actor has |
| | | | done internationally |
| | | | transactions with from the |
| | | | same country (by 2 digits |
| | | | code) before current event |
| iat_country_trx_count | float64 | secondary | the number of |
| | | | international events has |
| | | | occurred from this |
| | | | country, actor pair |
| unique_iatcountry | float64 | secondary | number of unique country |
| | | | (by 2 digit code) the actor |
| | | | has done international |
| | | | transactions with |
| ym | category | secondary | year and month of the |
| | | | event |
| CombinedVolumeRisk | float64 | secondary | risk assigned based on |
| | | | number of transactions |
| | | | done |
| CombinedAmountRisk | float64 | secondary | risk assigned based on the |
| | | | transaction event dollar |
| | | | amount |
| adj_CombinedNewCnxRisk_window | float64 | secondary | risk assigned based on |
| | | | making transaction with a |
| | | | new originator |
| | | | (either/both id, name) |
| Total_SEC_Risk | float64 | secondary | risk assigned based on the |
| | | | sec type of the event |
| CombinedLocationRisk | float64 | secondary | risk assigned based on the |
| | | | location the transaction |
| | | | going to (city, state) |
| IndividualNameRisk | float64 | secondary | risk assigned based on |
| | | | how suspicious the name |
| | | | called by the originator |
| NameRiskMultiplier | float64 | secondary | a factor assigned to the |
| | | | name risk for each event |

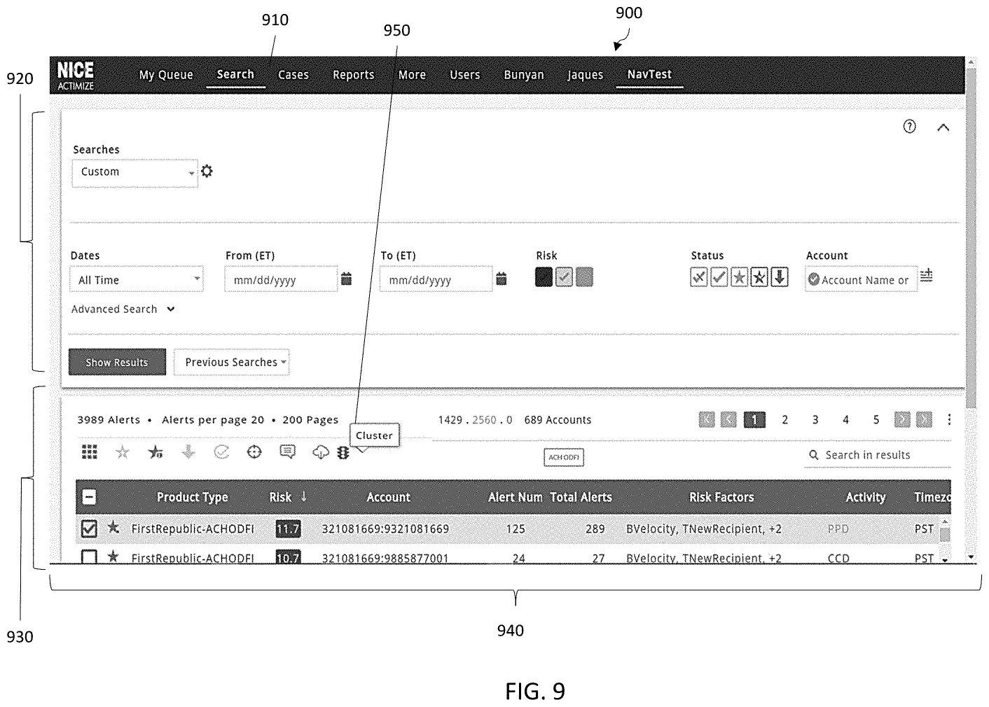

FIG. 9 is a user interface display screen 900 of an example transaction clustering system 100, according to at least one embodiment of the present disclosure. In the example shown in FIG. 8, the display screen 900 includes a top menu 910, search control block 920, search results block 930 showing multiple alerts 940, and a cluster button 950. The cluster button 950 may for example enable the option of clustering the alerts 940 in the search results block 930. If a specific alert 940 is chosen by the fraud analyst, the cluster button 950 may for example retrieve and display all the alerts similar to the selected alert (e.g., all the alerts belonging to the same cluster as the selected alert).

FIG. 10 is a user interface display screen 1000 of an example transaction clustering system 100, according to at least one embodiment of the present disclosure. In the example shown in FIG. 10, the display screen 100 includes a cluster menu 1010, cluster solution history 1020, common features list 1025, and cluster-specific alerted transaction list 1030. The cluster solution history 1020 may for example give the distributions of resolutions of all the cluster members (if resolved). The common features list 1025 may for example be a prioritized list of risk factors that are resulted from tell_me_whats_similar function, and may include each risk factor's cluster mean, selected transaction's value for that risk factor and the direction of increment from cluster mean to individual risk score. If the fraud manager wishes to look at any of the other clusters then (s)he can make a different selection from the cluster menu 1010.

After analyzing the cluster, if the fraud analyst decides to take action either on a particular alert or on all the alerts belonging to one cluster, then (s)he can, if desired, make use of actions buttons 1040. If desired, an automated action can also be set up that would automatically hold/release all current and future cluster members as future transactions are sorted into clusters. This sort of automation can reduce the workload and time spent by the analyst/fraud manager, and can provide a higher level of automatic alert resolution. The solution history 1020 of the cluster may be helpful for the fraud analyst to decide if the action is to be taken for that alert or not.

In some embodiments, the user interface may suggest an action based on the resolution history from other transactions in the cluster, or in similar clusters identified previously. In some embodiments, the user interface may suggest the next alert or alerts to be resolved, for example by identifying the closest alert from the cluster (or from a different cluster, if the current cluster is now finished) and recommend this as the next alert to be looked at, to minimize context switching and maximize efficiency.

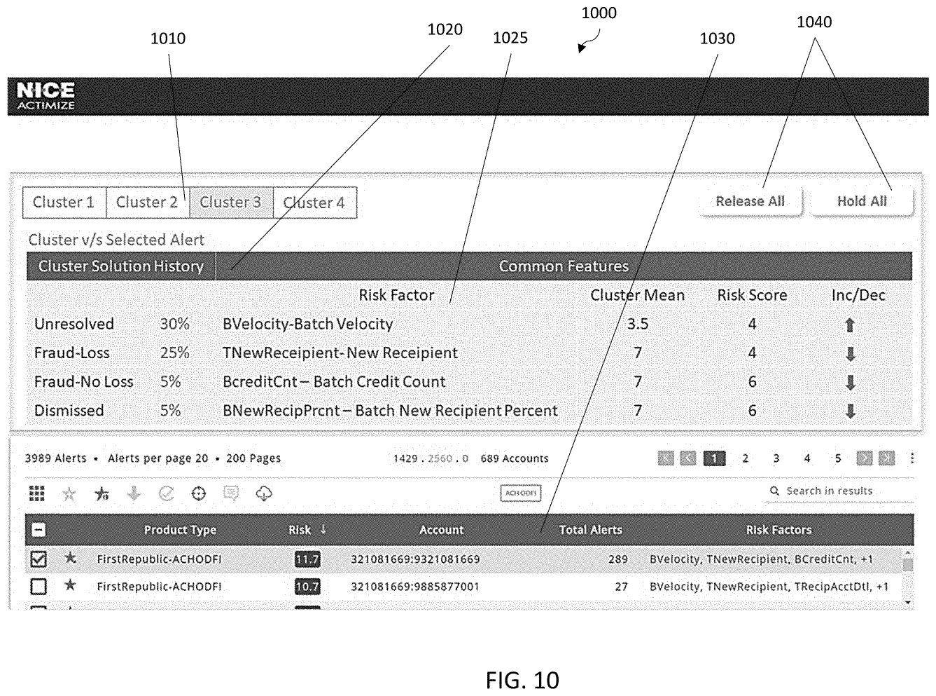

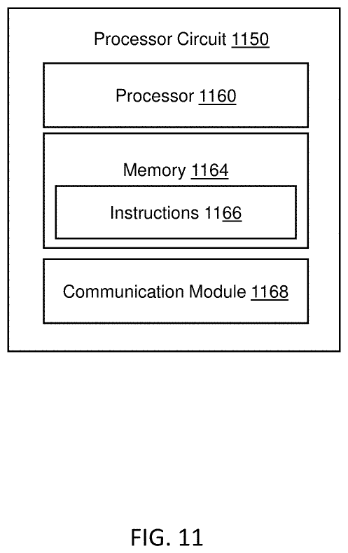

FIG. 11 is a schematic diagram of a processor circuit 1150, according to at least one embodiment of the present disclosure. The processor circuit 1150 may be implemented in the transaction clustering system 100, or other devices or workstations (e.g., third-party workstations, network routers, etc.), or on a cloud processor or other remote processing unit, as necessary to implement the method. As shown, the processor circuit 1150 may include a processor 1160, a memory 1164, and a communication module 1168. These elements may be in direct or indirect communication with each other, for example via one or more buses.

The processor 1160 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1160 may also include another hardware device, a firmware device, or any combination thereof configured to perform the operations described herein. The processor 1160 may also be implemented as a combination of computing devices, e.g., a combination of a DSP and a microprocessor, a plurality of microprocessors, one or more microprocessors in conjunction with a DSP core, or any other such configuration.

The memory 1164 may include a cache memory (e.g., a cache memory of the processor 1160), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1164 includes a non-transitory computer-readable medium. The memory 1164 may store instructions 1166. The instructions 1166 may include instructions that, when executed by the processor 1160, cause the processor 1160 to perform the operations described herein. Instructions 1166 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1168 can include any electronic circuitry and/or logic circuitry to facilitate direct or indirect communication of data between the processor circuit 1150, and other processors or devices. In that regard, the communication module 1168 can be an input/output (I/O) device. In some instances, the communication module 1168 facilitates direct or indirect communication between various elements of the processor circuit 1150 and/or the transaction clustering system 100. The communication module 1168 may communicate within the processor circuit 1150 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, or preset sharing between the processor and a central server) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G/LTE/WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the transaction clustering system advantageously provides improved workflow, decreased context switching, and reduced analysis times, and can thus significantly improve the throughput of a fraud analysis team. It is noted that the efficiency of the analyst may be considered a key business metric to optimize for in the compliance industry. The automated clustering algorithm can group most similar alerts together in real time, based on various complex risk factors, including non-human-readable risk factors, and can place these similar alerts in the analyst's queue. Where most of the alerts in the analyst's queue are similar, less time may be required to identify genuinely fraudulent transactions and the actions required to resolve them, thus improving the time and cost efficiency of fraud analysis teams or departments.

Accordingly, it can be seen that the transaction clustering system fills a long-standing need in the art, by addressing the limitations of present systems and improving the operation of fraud detection computer systems.

A number of variations are possible on the examples and embodiments described above. For example, different risk factors, different numbers of risk factors, different clustering algorithms, or different sorting criteria may be used. A greater or smaller number of clusters may be generated, from greater or smaller numbers of alerted transactions. The technology described herein may be implemented for fraud detection in financial or retail transactions, but may also be used for other applications where identifying and resolving anomalies in large datasets is desired.

The logical operations making up the embodiments of the technology described herein are referred to variously as operations, steps, objects, elements, components, layers, systems, subsystems, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the dimensional reduction integrated fraud management system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the transaction clustering system as defined in the claims. Although various embodiments of the claimed subject matter have been described above with a certain degree of particularity, or with reference to one or more individual embodiments, those of ordinary skill in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically analyze clusters of suspicious transactions, the system comprising:
a processor and a computer readable medium operably coupled thereto, the computer readable medium comprising a plurality of instructions stored in association therewith that are accessible to, and executable by, the processor, to perform operations which comprise:
receiving a plurality of risk factors;
receiving a plurality of suspicious transactions, wherein each transaction of the plurality of suspicious transactions comprises a respective set of values for the risk factors of the plurality risk factors;
with a clustering algorithm, based on the sets of values for the risk factors for the transactions of the plurality of transactions:
generating a plurality of data clusters;
assigning each transaction to a cluster of the plurality of data clusters; and for each cluster:
for each risk factor of the plurality of risk factors, computing a respective cluster mean and cluster standard deviation of the risk factor values for the transactions assigned to the cluster;
identifying risk factors of the plurality of risk factors for which the cluster standard deviation is below a respective threshold value for the risk factor; and
generating a list of the identified risk factors and their respective cluster means and cluster standard deviations, ranked in relation to their respective cluster standard deviations.

2. The system of claim 1, wherein the operations further comprise displaying the generated list, or a graphical representation thereof, to a user.

3. The system of claim 1, wherein the operations further comprise initiating an automated action based on the generated list.

4. The system of claim 3, wherein the automated action comprises, as to one of the plurality of suspicious transactions, at least one of blocking the transaction, allowing the transaction, alerting a customer associated with the transaction, blocking a customer associated with the transaction, or suggesting a resolution action to a user.

5. The system of claim 1, wherein the operations further comprise:
for each respective risk factor in the plurality of risk factors, computing a full data mean and full data standard deviation of the values for the respective risk factor for each transaction of the plurality of suspicious transactions.

6. The system of claim 5, wherein the respective threshold value for a respective risk factor is a function of the full data standard deviation for the respective risk factor, and wherein the generated list further comprises the full data mean and full data standard deviation for each risk factor of the identified risk factors.

7. The system of claim 6, wherein the respective threshold value for the respective risk factor is the full data standard deviation.

8. The system of claim 1, wherein the plurality of risk factors comprises at least one numerical risk factor and at least one categorical risk factor, and wherein the clustering algorithm comprises a K prototype clustering algorithm.

9. The system of claim 1, wherein the operations further comprise, when a current transaction of a cluster is selected by a user, suggesting a next transaction of the cluster to the user based on the respective values of the risk factors of the current transaction and next transaction.

10. The system of claim 1, wherein the operations further comprise, when a current cluster is selected by a user, suggesting a next cluster to the user based on the respective cluster means of the risk factors of the current cluster and the next cluster.

11. A computer-implemented method adapted to automatically analyze clusters of suspicious transactions, the method comprising:
receiving a plurality of risk factors;
receiving a plurality of suspicious transactions, wherein each transaction of the plurality of suspicious transactions comprises a respective set of values for the risk factors of the plurality risk factors;
with a clustering algorithm, based on the sets of values for the risk factors for the transactions of the plurality of transactions:
generating a plurality of data clusters;
determining a cost function of the variation in values for each risk factor in the plurality of risk factors;
by minimizing the cost function, assigning each transaction to a cluster of the plurality of data clusters; and
for each cluster of the plurality of data clusters:
for each risk factor of the plurality of risk factors, computing a respective cluster mean and cluster standard deviation of the risk factor values of the transactions assigned to the cluster;
identifying risk factors of the plurality of risk factors for which the cluster standard deviation is below a threshold value; and
generating a list of the identified risk factors and their respective cluster means and cluster standard deviations of their respective cost function, ranked in relation to their respective cluster standard deviations.

12. The computer-implemented method of claim 11, further comprising displaying the generated list, or a graphical representation thereof, to a user.

13. The computer-implemented method of claim 11, further comprising initiating an automated action based on the generated list.

14. The computer-implemented method of claim 13, wherein the automated action comprises, as to one of the plurality of suspicious transactions, at least one of blocking the transaction, allowing the transaction, alerting a customer associated with the transaction, blocking a customer associated with the transaction, or suggesting a resolution action to a user.

15. The computer-implemented method of claim 11, further comprising:
for each respective risk factor in the plurality of risk factors,
computing a full data mean and full data standard deviation of the values for the respective risk factor for each transaction of the plurality of suspicious transactions.

16. The computer-implemented method of claim 15, wherein the threshold value for a respective risk factor is a function of the full data mean for the respective risk factor, and wherein the generated list further comprises the full data mean and full data standard deviation for each risk factor of the identified risk factors.

17. The computer-implemented method of claim 16, wherein the threshold value for the respective risk factor is the full data standard deviation of the respective risk factor.

18. The computer-implemented method of claim 11, wherein the plurality of risk factors comprises at least one numerical risk factor and at least one categorical risk factor, and wherein the clustering algorithm comprises a K prototype clustering algorithm.

19. The computer-implemented method of claim 11, further comprising, when a current transaction of a cluster is selected by a user, suggesting a next transaction to the user based on the respective risk factors of the current transaction and next transaction.

20. The computer-implemented method of claim 11, further comprising, when a current cluster is selected by a user, suggesting a next cluster to the user based on the respective cluster means of the risk factors of the current cluster and the next cluster.
